(19) United States
(12) Patent Application Publication
(10) Pub. No.: US 2015/0033721 A1
(43) Pub. Date: Feb. 5, 2015

(54) Liquid Nitrogen Conventional Generator

(71) Applicant: Scott Clair Pockrandt, Ridgecrest, CA (US)

(72) Inventor: Scott Clair Pockrandt, Ridgecrest, CA (US)

(21) Appl. No.: 13/987,480

(22) Filed: Jul. 30, 2013

(51) Int. Cl. F15B 1/02

(52) U.S. Cl. CPC F15B 1/024
USPC 60/327

(57) ABSTRACT

The Liquid Nitrogen Conventional Generator operates by using electrical energy from an existing power plant to collect, cool, store and utilize Nitrogen from the atmosphere to generate power, in any form required, to provide continuous, augmented, supplemental or alternate output of power in any predetermined form, including but not limited to electrical, mechanical and/or hydraulic, which may be produced individually or in any combination.

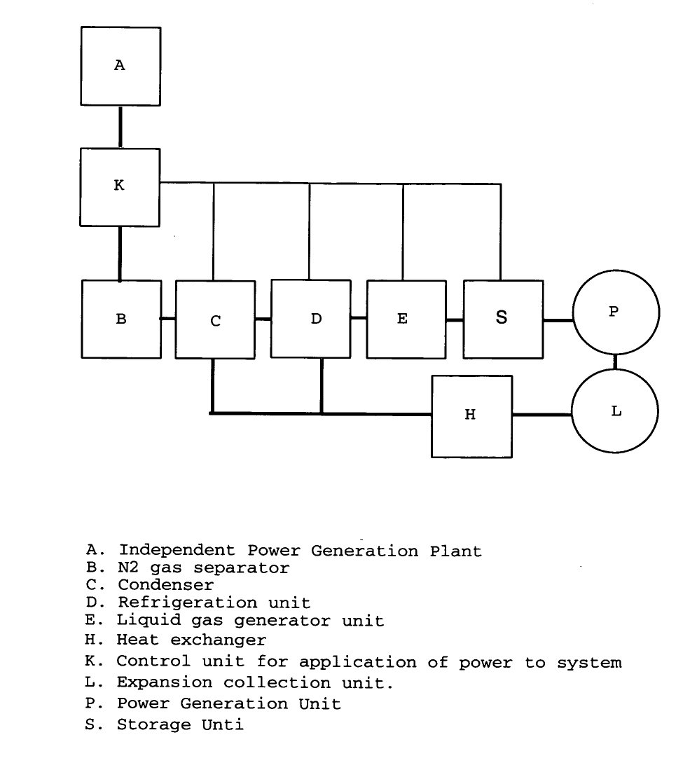

Nitrogen is extracted from the atmosphere, condensed and cooled, stored in liquid form and then expanded to be applied to the generation unit which is selected to provide the type of power needed, allowing reduction of size of the conventional plant supplying power to this system while maintaining the output of said plant. And recycling the expanded Nitrogen gas within the system to provide increased efficiency.

### FEDERALLY SPONSORED RESEARCH

Not applicable.

### SEQUENCE LISTING OR PROGRAM

Not applicable.

### DRAWING 1

Power, in the form of electricity, is applied from an existing power generation plant (A), to the System through the Control Unit (K) which regulates the action of, application of power to, and generation of power by, the System. Note that the use of the term “gas” in this paper refers to Nitrogen gas in any physical form, including liquid, gaseous, and others.

Atmospheric Nitrogen gas which comprises approximately 80% of Earth's atmosphere, is separated by the N2 Gas Separator (B).

The Condenser (C) precipitates the Nitrogen, which is then put into liquid form by the Refrigeration Unit (D), and stored for use in Storage Unit (S).

When required and for any duration, including continuous operation, liquid Nitrogen is applied to the Liquid Gas Power Generator Unit (E) which provides the necessary actions to expand the Nitrogen from any physical form, to provide drive in the form of a workable gas to the Power Generation Unit (P), which in turn produces the required amount and form of power to be used, including, but not limited to, mechanical, hydraulic, electrical, or any other form.

The gas which passes through the Power Generation Unit (P), is collected in the Expansion Collection Unit (L), and recycled through a closed system to the Heat Exchanger (H) which is used in combination with Condenser (C), and Refrigeration Unit (D) for re-use in the System.

1. I have developed a process and method for storing and utilizing the output of an existing power generation plant to provide continuous, augmented, alternate and/or supplemental output of power of any predetermined type, including but not limited to electrical, mechanical and hydraulic, which can be produced individually or in any combination, without additional consumption of additional fuel, or production of additional greenhouse gases.
